(19) United States
(12) Patent Application Publication
(10) Pub. No.: US 2022/0138615 A1
(43) Pub. Date: May 5, 2022

(54) MACHINE LEARNING-BASED PRIVILEGE MODE

(71) Applicant: Lighthouse Document Technologies, Inc. (d/b/a Lighthouse), Seattle, WA (US)

(72) Inventors: Karl Sobylak, Latham, NY (US); John Charles Olson, Seattle, WA (US); Jason Wolosonovich, Phoenix, AZ (US)

(21) Appl. No.: 17/085,979

(22) Filed: Oct. 30, 2020

(51) Int. Cl. G06N 20/00; G06Q 10/10; G06F 40/166; G06F 40/279

(52) U.S. Cl. CPC G06N 20/00; G06F 40/279; G06F 40/166; G06Q 10/107

(57) ABSTRACT

Embodiments of the present disclosure may relate to apparatus, process, or techniques to develop and to implement a machine learning-based privilege model to identify, for a given document production request, those documents that are privileged and do not need to be provided as part of the production request. In embodiments, during the training of the machine learning-based privilege model, each training document may be broken down into a pure text sub-document and a header only sub-document that includes, for example, email headers and their contents. The privilege model includes (1) a text model that is trained using pure text sub-documents, and (2) a header model that is trained using header only sub-documents, typically extracted from emails. Other embodiments may be described and/or claimed.

### TECHNICAL FIELD

Embodiments of the present disclosure are related to the field of information processing and, in particular, to creating models for identifying privileged documents.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

When a government or some other entity requests documents from a business entity, the business entity may not be required to turn over documents having a certain character or type. For example, during a lawsuit, investigation, or some other legal action, a document may be considered privileged and therefore may not be not turned over in response to a document production request. For example, a document may be privileged if it is a document or an email communication subject to the attorney-client privilege that protects confidential communications between the client and the client's legal advisor, for example for the purpose of legal advice.

With documents and email communications stored electronically, there may be hundreds of thousands if not millions of documents to sort through to determine whether any particular document may be privileged. In legacy implementations, these documents may be searched by hand, or searched using electronic searching techniques for particular words or phrases. These approaches may be slow and costly, inaccurate, and may not provide a timely turnover of non-privileged documents that are subject to the document request. There is a high rate of false positive returns from these legacy methods of searching for privileged content. Inadvertently turning over a privileged document to opposing parties in a legal matter provides a significant risk to the entity burdened with producing non-privileged documents. Ensuring that all privileged material is withheld or redacted is the top priority in any production situation. Consistency of privilege designations across matters is critical to maintaining the privilege.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a context diagram showing a high level data/document flow for implementing a machine learning-based privilege model, in accordance with various embodiments.

FIG. 2 illustrates an example process for training a privilege model that includes a text model and a header model, in accordance with various embodiments.

FIG. 3 illustrates an example process for preprocessing text for training prior to text model training, in accordance with various embodiments.

FIG. 4 illustrates an example process for training the text model, in accordance with various embodiments.

FIG. 5 illustrates an example process for text model post-training validation and deployment, in accordance with various embodiments.

FIG. 6 illustrates an example process for preprocessing headers for training prior to header model training, in accordance with various embodiments.

FIG. 7 illustrates an example process for identifying emails as a part of the process for preprocessing headers, in accordance with various embodiments.

FIG. 8 illustrates an example process for identifying recipients of emails as a part of the process for preprocessing headers, in accordance with various embodiments.

FIG. 9 illustrates an example process for categorizing the identified recipients of emails as a part of the process for preprocessing headers, in accordance with various embodiments.

FIG. 10 illustrates an example process for training the header model, in accordance with various embodiments.

FIG. 11 illustrates an example process for header model post-training validation and deployment, in accordance with various embodiments.

FIG. 12 illustrates an example process for using a machine learning-based privilege model to identify documents is privileged or not privileged, in accordance with various embodiments.

FIG. 13 illustrates an example computing device 1300 suitable for use with various disclosures herein, and in particular to FIGS. 1-12, in accordance with various embodiments.

FIG. 14 depicts a computer-readable storage medium that may be used in conjunction with the computing device 1300, in accordance with various embodiments.

### DETAILED DESCRIPTION

Embodiments described herein may be directed to apparatus, process, or techniques used to develop and to implement a machine learning-based privilege model. The machine learning-based privilege model may also be referred to as the privilege model. The privilege model may be used to identify, for a given document production request, those documents within a universe of documents that are privileged and do not need to be provided as part of the production request. In embodiments, the machine-learning-based privilege model may be trained and validated using a subset of the universe of documents, as described in more detail below. Once the privilege model has been trained and validated, the privilege model may be updated using other subsets of the universe of documents. Although a common use of the privilege model as described herein may be in conjunction with a legal request for document production during the discovery phase of a legal action, there may be other uses. For example, in other embodiments the privilege model may be tailored to identify the likelihood that a document meets any relevant characteristics of a desired subset of a group of documents.

The term document as used herein may refer to electronic documents such as Microsoft Office documents, Adobe PDF documents, notepad, and/or any other text-based documents. In embodiments, a document may be an electronic mail message (email, chat, or other), a memo, a note, or any other document that may include text. In embodiments, a document may include a graphics file such as an embedded graphic within a Microsoft Word document or a PDF document. In embodiments, a document that has a combination of graphics and text may undergo an optical character recognition (OCR) process to identify text within the document.

In embodiments, during the training of the machine learning-based privilege model, each training document may be broken down into a pure text sub-document and a header only sub-document that includes, for example, email headers and their contents. The privilege model includes a combination of two independent but related machine learning-based privilege models: (1) a text model that is trained using pure text sub-documents, and (2) a header model that is trained using header only sub-documents, that are typically extracted from emails.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

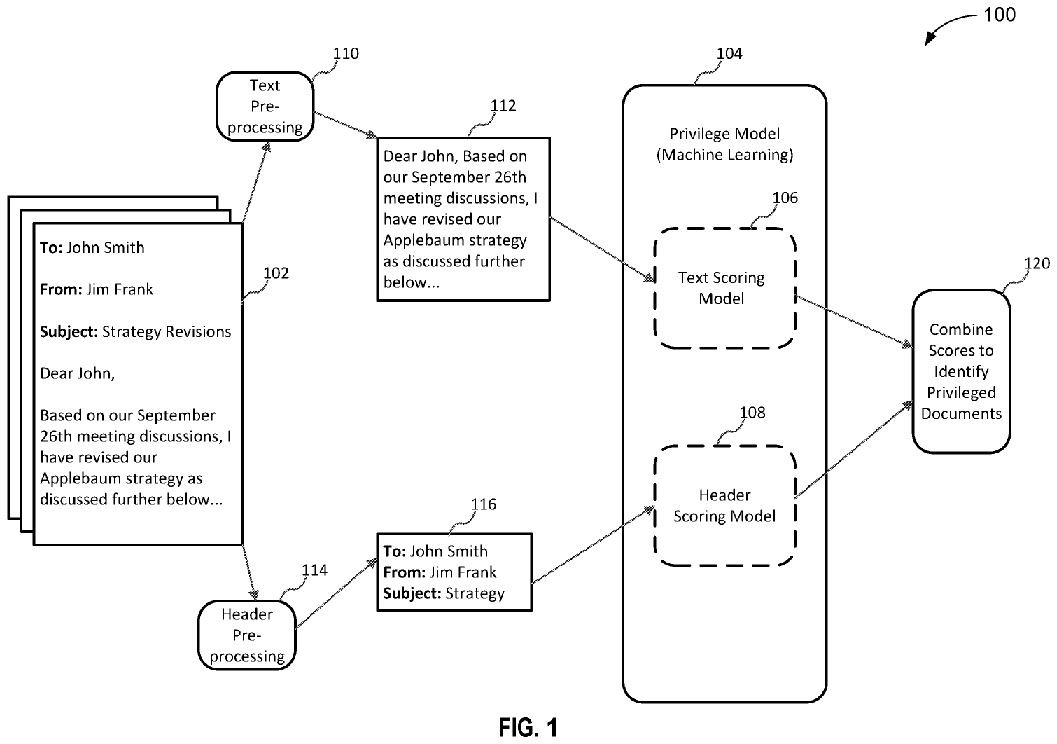

FIG. 1 illustrates a context diagram showing a high level data/document flow for implementing a machine learning-based privilege model, in accordance with various embodiments. Diagram 100 shows a high level view of a single document 102 out of a set of documents to which the machine learning-based privilege model 104, which may also be referred to as the privilege model 104, is to be applied. The privilege model 104 includes a text scoring model 106, and a header scoring model 108.

In embodiments, document 102 may be split into two sub-documents. For the first sub-document, a text preprocessing module 110 may take the document 102 and strip out any headers found within the document 102. This may include, for example, email headers including To:, From:, and Subject: and any of the fields associated with the headers. The text preprocessing module 110 may also remove extraneous punctuation, such as new lines, extra white space, or other punctuation marks. The result of the text preprocessing module 110 is a text-only sub-document 112. This text-only sub-document 112 is then applied to the privilege model 104, in particular the text scoring model 106, to come up with a numerical score that indicates the likelihood, based upon the text-only of document 102, that the document 102 is privileged.

For the second sub-document, a header preprocessing module 114 may take the document 102 and strip out everything except for headers found within the document 102 to create the header-only document 116. The header only sub-document 116 may include, for example, only email headers including To:, From:, and Subject:, and any of the fields associated with the headers, with all other text or graphics removed. The header preprocessing module 114 may also remove extraneous punctuation from the header only sub-document 116. The header only document 116 is then applied to the privilege model 104, in particular the header scoring model 108, to come up with a numerical score that indicates the likelihood, based upon only the headers of document 102, that the document 102 is privileged.

The score from the text scoring model 106 and the score from the header scoring model 108 are then used by a score combining module 120 to identify a combined score to indicate the likelihood of whether the document 102 is privileged.

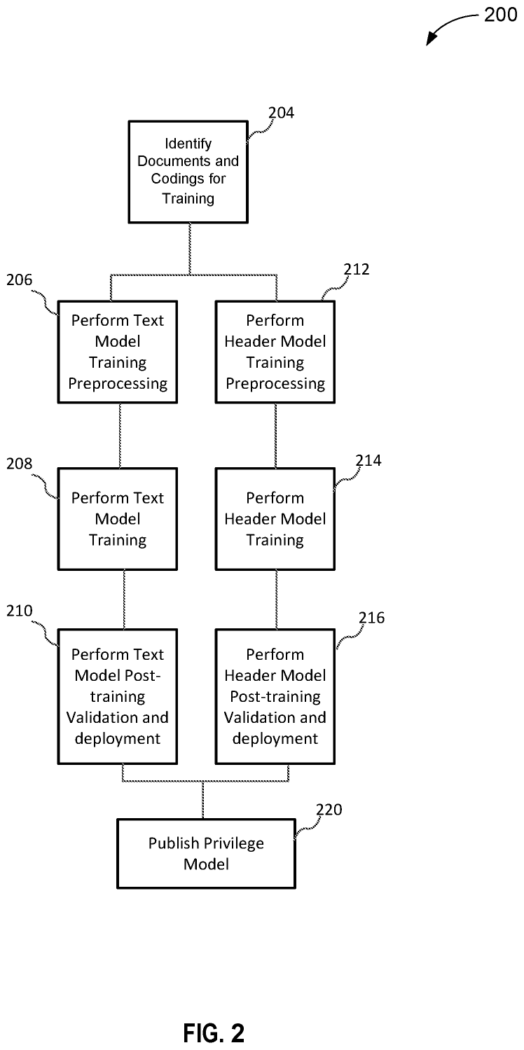

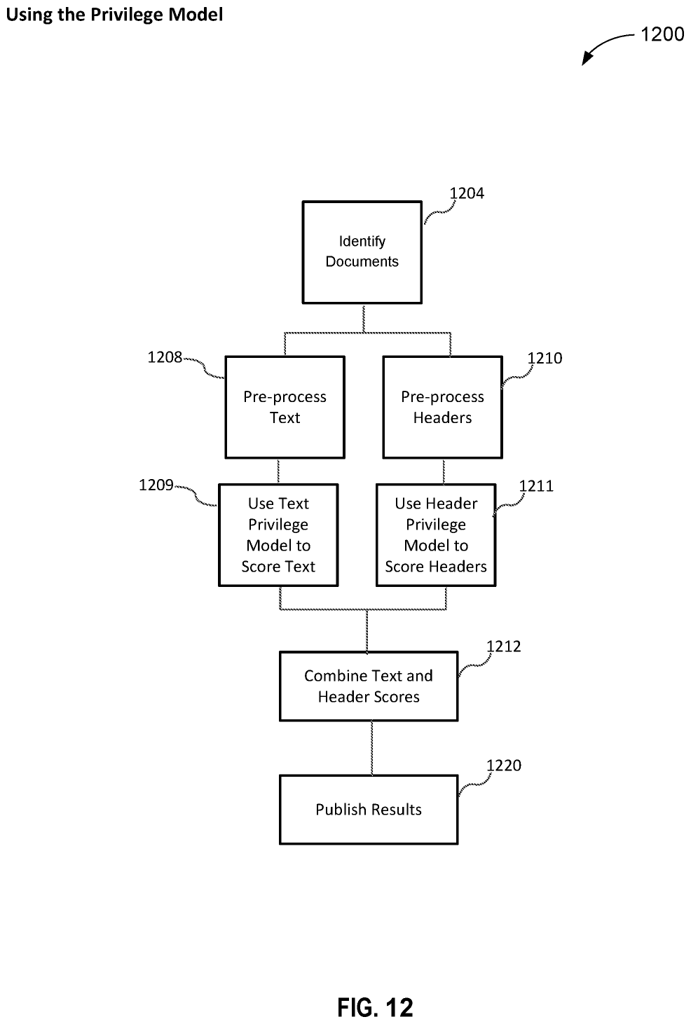

Embodiments of training components of the privilege model 104, in particular training the text scoring module 106 and training the header scoring module 108, is described herein with respect to FIGS. 2-11. Embodiments of using the trained privilege model 104 is described in more detail with respect to FIG. 12.

FIG. 2 illustrates an example process for training a privilege model that includes a text model and a header model, in accordance with various embodiments. It should be noted that after block 204, the branch that includes block 206, 208, 210 and the branch that includes block 212, 214, 216 may be performed in parallel, may be performed consecutively, or just one branch be performed, for example branch 206, 208, 210 and not branch to 212, 214, 216.

At block 204, the process identifies documents and codings for training the machine learning-based privilege model. In embodiments, this may include identifying source materials including document text, attorney work product, and/or configuration files may exist on a particular computer system, one or more network computer systems, and/or in the cloud. In embodiments, these documents may be referred to as a universe of documents. In embodiments, this process may be performed using a cloud-based service, such as Microsoft™ Azure, Amazon™ Web Services (AWS™), or some other cloud-based service.

Codings may refer to a human decision as to whether a document or group of documents is attorney-client privileged or not attorney-client privileged in whole or in part. In other embodiments, codings may refer to other characteristics or classifications to determine whether or not a document belongs to a set of documents based on case-specific or document specific content, meaning, or labelling. In embodiments, the new documents and new text may include email documents as well as non-email documents. In embodiments, a subset of these new documents may be used to train the privilege model, and another subset of these new documents may be used to validate the privilege model.

In embodiments, the identified documents will be coded as either privileged or not privileged for the subsequent training process. In embodiments outside of the legal environment, this coding may include any type of coding to distinguish a subset of documents from another subset of documents, and may include a number of codings greater than two.

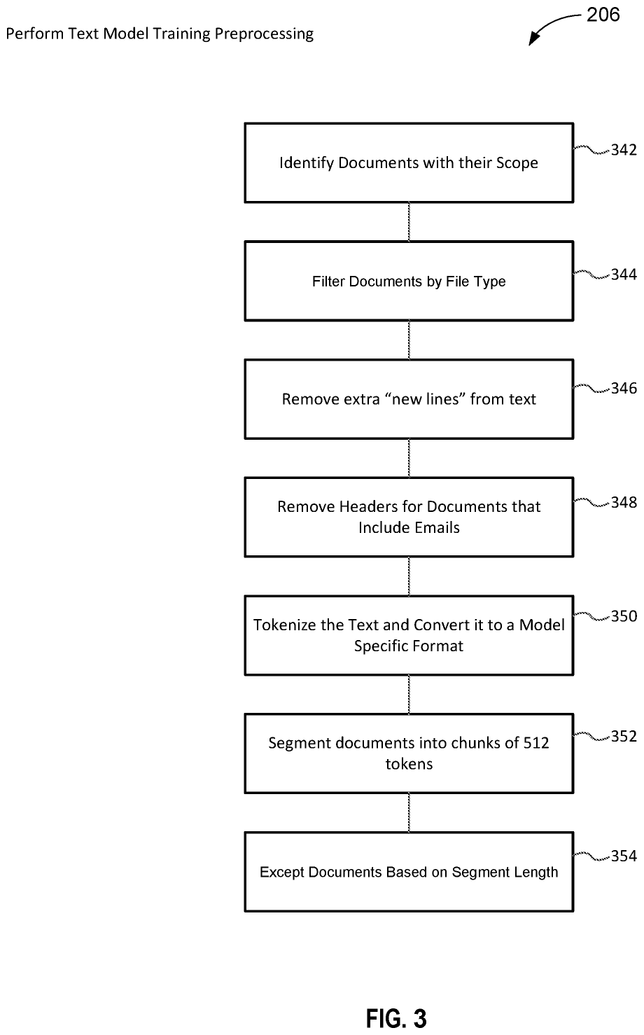

At block 206, the process may perform text model training preprocessing. At block 206, documents, that include text documents as well as email documents, are processed for text model training. Block 206 embodiments are described in greater detail with respect to FIG. 3. FIG. 3 illustrates an example process for preprocessing text for training prior to text model training, in accordance with various embodiments.

In FIG. 3, process 206, text model training text preprocessing, may start with block 342, where the process may identify documents with their scope. For example, this may include identifying each of the documents as either responsive and privileged, or not privileged. From these documents, a set of these documents will be used for training. In embodiments, another set of these documents will be used to validate/evaluate the text model portion of the privilege model once it has been trained.

At block 344, the process may filter documents of block 342 by file type. For example, text files that include emails, or where documents may be included in the training set. However, certain file types may be excluded from the training set. For example, documents may be excluded because they are not directly generated by a human or are tabular in nature, for example certain Excel files, binary executables, or generated source code files.

At block 346, the process may remove extra “new lines” from the text of the document. In embodiments, other modifications may be made to the text of the documents, such as removing extra “new lines,” or removing other punctuation or graphics from the document to get the modified document closer to a pure text form.

At block 348, the process removes headers for documents that include emails. In embodiments, email headers may include: To:, From:, CC:, and BCC: or Subject: keywords, along with additional text associated with the keywords. In embodiments, recipient names and email addresses may also be removed, and subject line text may be removed. Note: email headers including recipient names are processed separately to create a header model. This is discussed further with respect to block 212 “Perform Header Model Training Preprocessing” of FIG. 2.

At block 350, the process may tokenize the text and convert it to a model specific format. In embodiments, the model specific format may correspond to a tokenization of the text. This tokenize text may be in a specific format used by a particular transform algorithm, such as DistilBERT. In embodiments, a token may be identified by one or more words of text.

At block 352, the process may segment documents into chunks of 512 tokens. The resulting tokens created at block 350 are segmented into individual segments that are 512 tokens in length. In embodiments, a different number of tokens may be used.

At block 354, documents may be excepted from a training or validation set depending on segment length. In embodiments, this length may be identified by the number of segments that make up the document. For example, documents that contain more than a certain threshold number of segments, for example 400 segments, may be not included in the training set. In embodiments, documents that have zero segments, or empty documents, maybe not included in the training set either.

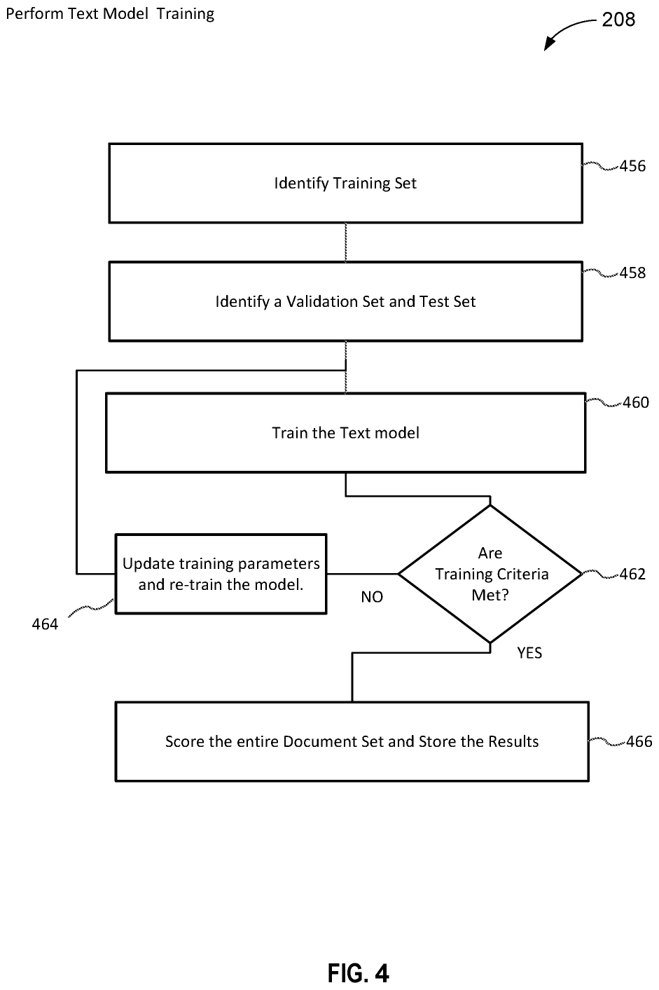

Returning now back to FIG. 2, at block 208, the process performs text model training. Block 208 is described in more detail in FIG. 4. FIG. 4 illustrates an example process for training the text model, in accordance with various embodiments. At block 456, a training set of documents is identified. In embodiments, this training set is taken from the identified documents (e.g. privileged, not privileged, etc.), as described with respect to block 204 of FIG. 2. This training set of documents will be used to train the text model.

In embodiments, the training set of documents may be a selected random sample out of the entire document set. For example, the training set may include around 12,500 privileged documents and 12,500 non-privileged documents. In embodiments, the number of privileged documents and non-privilege documents would be an equal number, or equally balanced. In other embodiments, the split between privileged documents and non-privilege documents maybe different numbers, or not evenly balanced.

At block 458, the process identifies a validation set and a test set of documents. Similar to block 456, the validation and test set of documents is taken from the identify documents of block 204 of FIG. 2. The validation and test set of documents is used to validate and test the text model after it is trained, as discussed with respect to block 210 of FIG. 2. The validation and test set of documents may be different than the training set of documents. The validation set is used to support the optimization of deep learning within the text model. The test set is used to support confirming the effectiveness of the deep learning model on documents it has not seen before. In embodiments, it may be important to use a set of documents different than the set with which the text model was trained, to properly validate the text model.

In embodiments, a validation set may be selected out of the training set, so that the validation set represents a proportionate of privilege versus non-privilege that is more in line with the global proportion of documents. For example, in the global set, there may be 5% privileged and 95% non-privileged documents. Thus, a proportional split of 5% to 95% are taken from the training set to create a validation set.

At block 460, the text model is trained. The identified training documents, that have been preprocessed at block 206, are used to train the text model. In embodiments, the model may be trained using DistilBERT, using an un-cased version. Other versions of DistilBERT, or other training tools, may be used. In embodiments, default parameters may be used, or may be specifically selected. For example, an initial set of parameters for DistilBERT may have a learning rate equal to 5e⁻⁵, a batch size of 32, and an Epochs setting to 2.

At block 462, a query is made whether training criteria are met. In embodiments, the training criteria may be a metric, for example a metric indicating a target loss accuracy, depth for recall at specified percentage, or F1 Measure. A depth for recall metric could be described as a target of capturing 80% of all privilege documents in the top 20% of the population by predicted privileged score. If the training criteria is not met, then at block 464 training parameters are updated, and at block 460 the text model is retrained using the updated training parameters. Note that in embodiments, if the loop has run a threshold value number of times and the model is still not able to meet the training criteria, then an error message may be sent to indicate further analysis of the text model is required and the current criteria that are actually met may be indicated. In embodiments, the process 400 may adjust parameters based on the results of prior training runs in an attempt to reach optimal goal metrics. In some embodiments, if the training criteria is not met, or if the training criteria is not met within a certain threshold amount, then the process may move to block 466. In other embodiments, if the training criteria is not met, or if the training criteria is not met within a certain threshold amount, then the process may cause the results to be presented to a user and request approval or manual intervention before moving to block 466

Otherwise, if the training criteria are met, then at block 466, the process scores the entire document segment set and stores the results. In embodiments, not just the training set data scored, but all documents are scored using the model, and this score is stored in a database. In embodiments, the process may score each 512 length token segment identified above. Once the scores for each segment are calculated, the system creates a single score for each document record from the underlying segment scores. These scores may then be combined using statistical methods, for example a max segment score or mean segment scores. In embodiments, other statistical or mathematical methods may be used to combine the resulting scores. In embodiments, this resulting data may be stored in a relational database and used for general reporting.

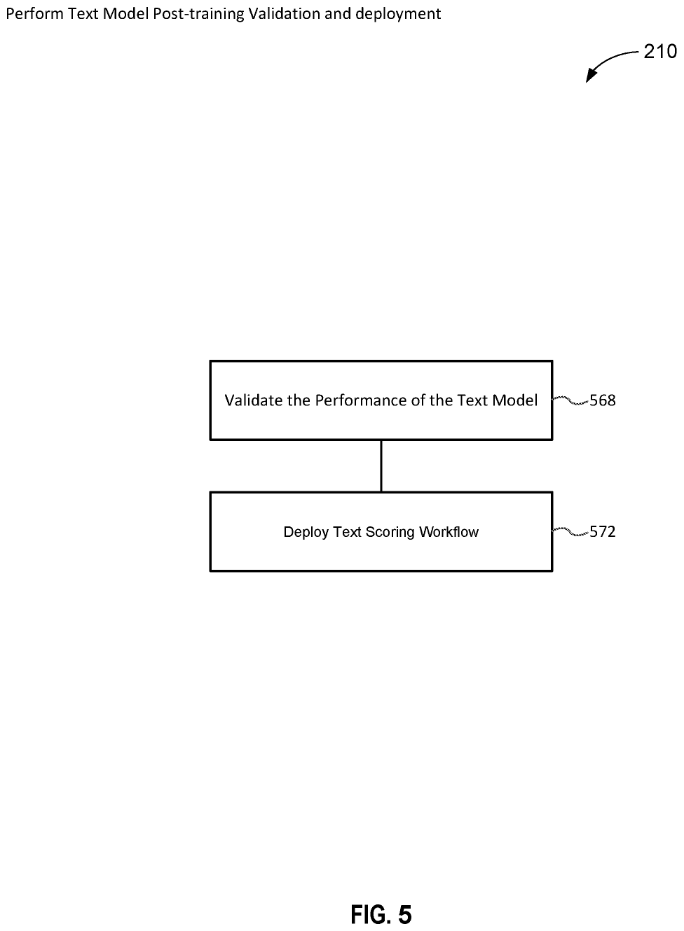

Referring now back to FIG. 2, at block 210, the process performs text model post-training validation and deployment. At this point, the text model has been created with the desired performance metrics based on the text training criteria. Now, the text model performance metrics can be validated and/or reviewed. Block 210 is described in more detail with respect to FIG. 5. FIG. 5 illustrates an example process for text model post-training validation and deployment, in accordance with various embodiments. At block 568, the process validates the performance of the text model. In embodiments, this may be performed as a human quality control process prior to the text model portion of the privilege model being deployed. The user will review reporting showing all models and their model metrics, including precision, recall, F1, and depth for recall, and then confirm if the selected model should be deployed or if it should go to a manual process for additional model training.

At block 572, the confirmed text model may then be deployed to a text scoring workflow. This deployment may be to a machine learning service (MLS) to support scoring of new documents through an operational pipeline. In embodiments, the model may be deployed using Azure™ Machine Learning Services (AMLS) for inferencing predictions on new documents that enter the system.

This concludes the creation and validation of the text model portion of the privilege model. The description now proceeds to the header model portion of the privilege model.

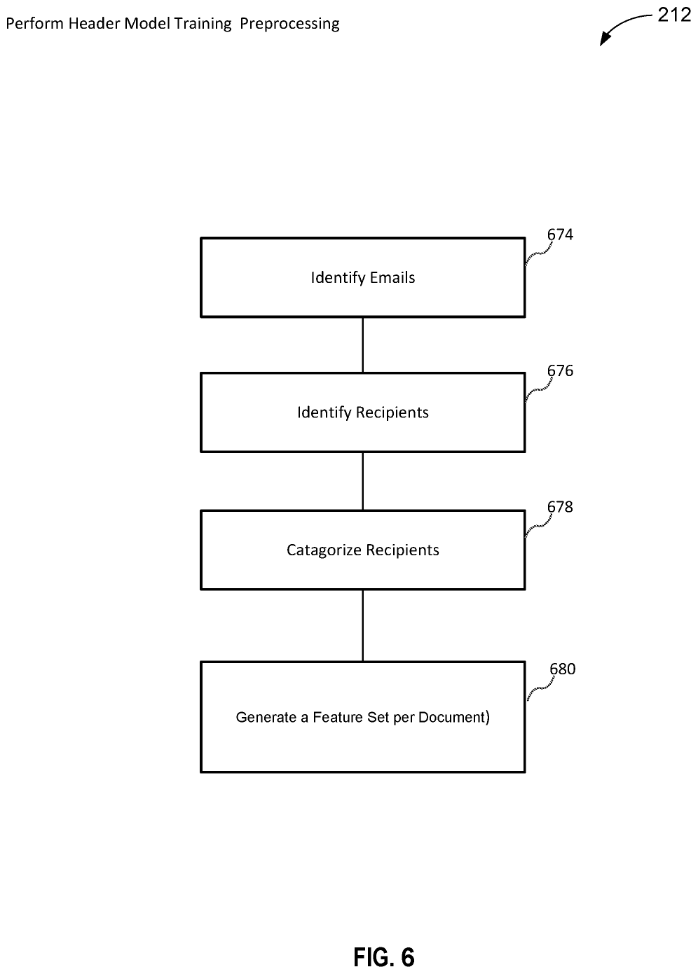

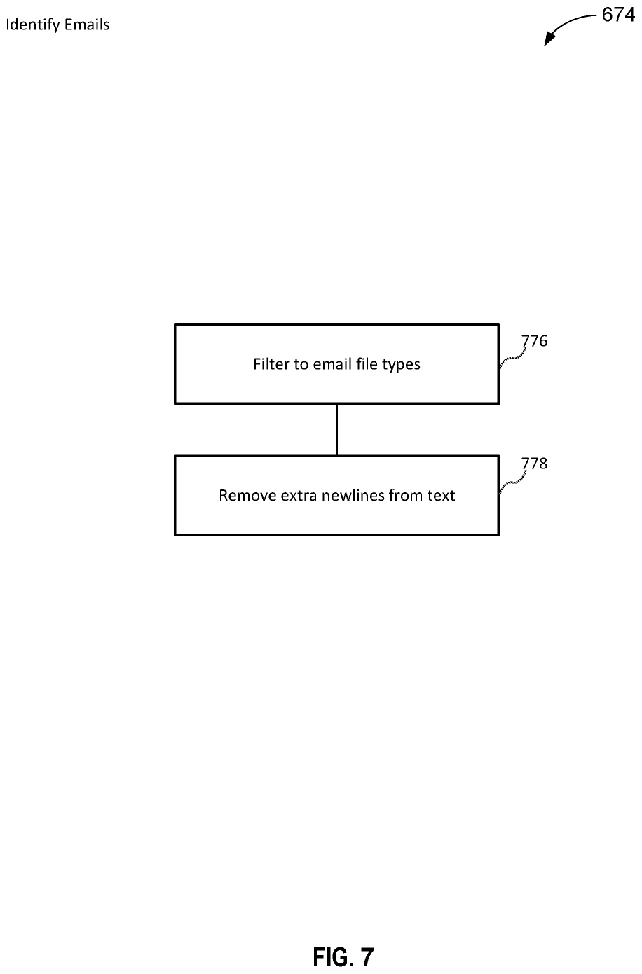

Referring back to FIG. 2, at block 212 the process performs header model training preprocessing. This header preprocessing is described in greater detail with respect to FIG. 6. FIG. 6 illustrates an example process for preprocessing headers for training prior to header model training, in accordance with various embodiments. At block 674, emails are identified that exist within the identified documents 204 of FIG. 2. Block 674 is described in greater detail with respect to FIG. 7. FIG. 7 illustrates an example process for identifying emails as a part of the process for preprocessing headers, in accordance with various embodiments. At block 776, the process may filter through documents, for example all the documents that are identified from the pulled new documents, identified in block 204, to identify which documents are emails. This filtering may include text searching to identify characteristics of emails, such as a To:, From:, CC:, BCC: or Subject: keywords and associated text within the document. At block 778, the process may remove extra new lines from email documents to maximize the amount of text versus white space within the email document.

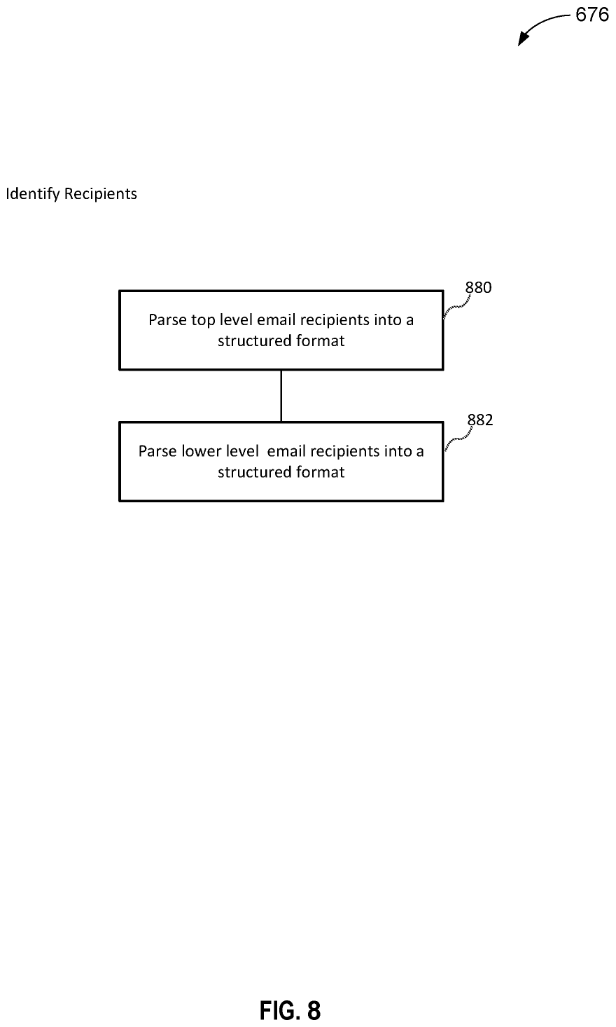

Returning now to FIG. 6, at block 676 the process may identify recipients. In embodiments, this may include identifying names, aliases, and/or full email addresses of people identified in the To:, From:, CC:, and/or BCC: fields of the email. Block 676 is described in greater detail with respect to FIG. 8. FIG. 8 illustrates an example process for identifying recipients of emails as a part of the process for preprocessing headers, in accordance with various embodiments. At block 880, the process may parse top level email recipients into a structured format. The structured format may be stored in a database or a temporary table held within computer memory. In embodiments, a top-level email recipient is associated with the most recent email in an email chain described by the document. In embodiments, the structured format may include a table that stores each unique email address and its associated role, and/or a table that stores each email and its associated email addresses, the type of participant (To:, From: CC:, and/or BCC:, and the level in the email (e.g. top or lower) it was found in. In embodiments, the two tables linked to each other to provide information, for example what the roles of the recipients were in each email and at what level.

At block 882, the process may parse lower level email recipients into a structured format. In embodiments, lower level email recipients are associated with various emails within an email chain described by the document that are not at the top level.

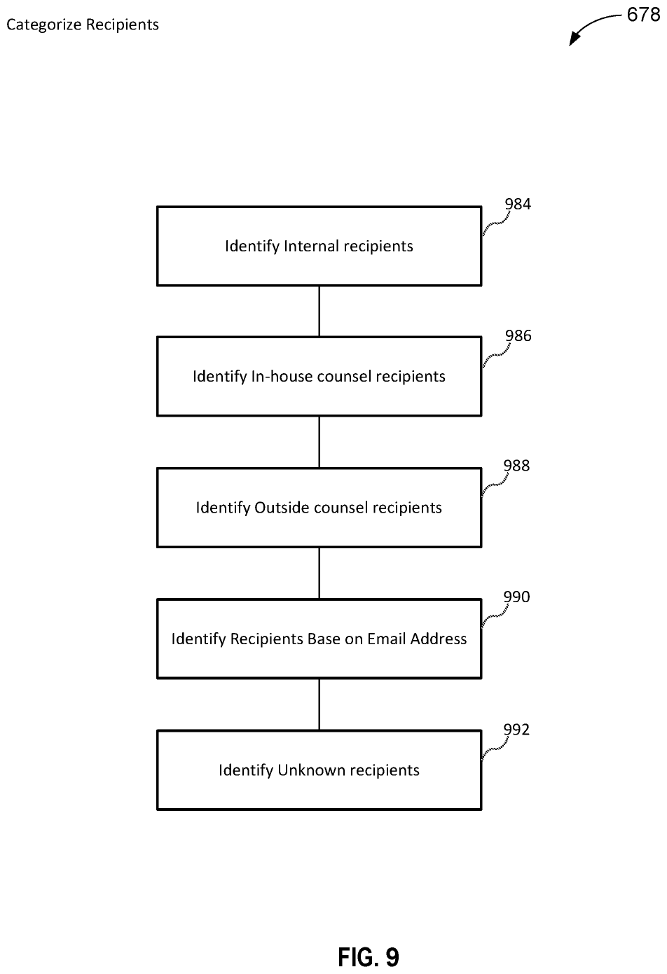

Returning now to FIG. 6, performing header model entered training preprocessing, a document identified as an email has been added to a structured data set, thus each email address in the email is known, the type of email participant (e.g. From, To, CC, BCC) is known and the header level of the email is known (top level or lower reply). At block 678 the process may include categorizing recipients, which is described in further detail with respect to FIG. 9.

FIG. 9 illustrates an example process for categorizing the identified recipients of emails as a part of the process for preprocessing headers, in accordance with various embodiments. At block 984, the process may identify internal recipients of email. In embodiments, an internal recipient may be an employee, in-house counsel, outside counsel, third parties, contractor, or some other person that has a close relationship with the business entity such that they may fall within the scope of the asserted privilege. At block 986, the process may identify in-house counsel recipients. In embodiments, in-house counsel may include employees that are attorneys, paralegals, or legal staff that work at one or more sites of the business entity. In embodiments, in-house counsel may also include legal contractors that are working under contract with the business entity.

At block 988, the process may include identifying outside counsel recipients. In embodiments, outside counsel may include lawyers, paralegals, and/or legal staff that work for one or more law firms that have the business entity as a client. At block 990, the process may include identifying recipients based on their email address. For example, email addresses that end in .gov or .edu. Other examples may include email addresses that indicate Internet service providers, for example karls@verizon.com indicates “Verizon” as the Internet service provider. At block 992, the process may identify unknown recipients. In embodiments, this may include comparing identified names or email addresses to the structured data set or too one or more databases to determine whether the name or email has not been previously associated with the business entity.

It should be appreciated that the examples given with respect to FIG. 9 are a non-exhaustive list of how recipients may be categorized during preprocessing for the model training.

Returning now to FIG. 6, performing header model training preprocessing, at block 680 the process generates a feature set per document. In embodiments, this generated feature set to include, per document, a count of recipients by recipient type. In embodiments, the generated feature set may include at what level the recipient is (top level or an earlier reply), the number of email domains, the number of recipients, and in which email field the recipient associated with, for example TO: From:, CC: BCC: and the like. In embodiments, the generated feature set may be used to identify other as yet undetermined aspects of a document in addition to privilege. For example, junk documents, responsiveness, and/or other issue coding. This completes the perform header model header training preprocessing example embodiment described in FIG. 2 block 212.

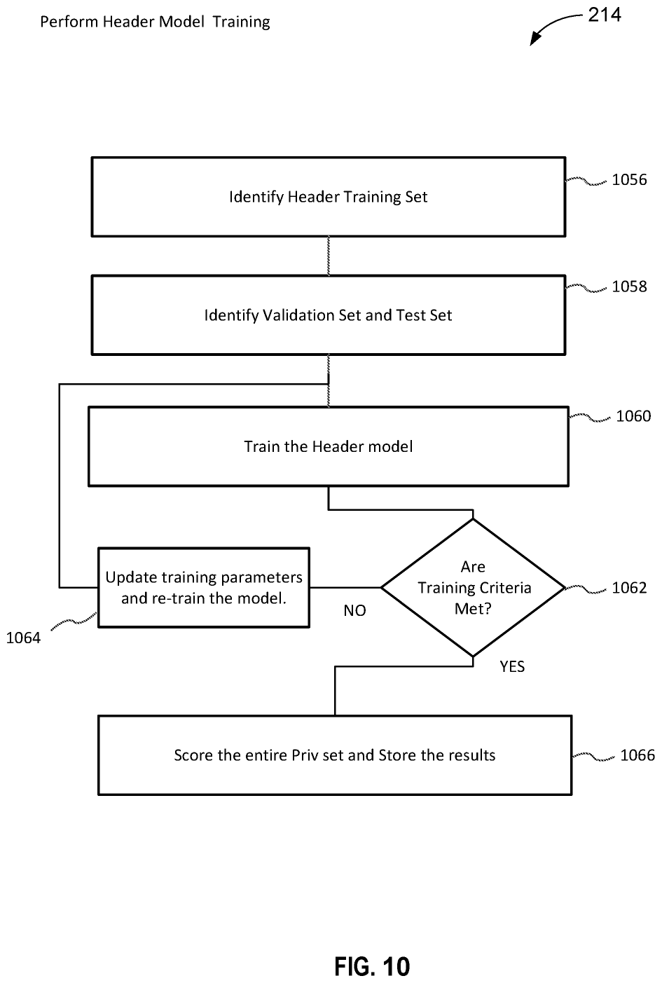

With respect to FIG. 2, Block 214, header model training is performed. Block 214 is described in greater detail with respect to FIG. 10. The embodiment described in FIG. 10 may be similar to the embodiment described in FIG. 4. FIG. 10 illustrates an example process for training the header model, in accordance with various embodiments. At block 1056, a training set is identified. In embodiments, this training set is taken from the identified documents of block 204 of FIG. 2, which deals with text, with a few differences. Block 1056 deals with headers, including email headers within documents. The documents selected from training the classifier are random and stratified by level of privilege for the document corpus, that being if 5% of the overall corpus are privileged then the training set will consists of 5% documents coded privileged and 95% documents coded not privileged. For example, the training set may include around 1,250 privileged documents and 23,750 non-privileged documents.

At block 1058, a validation and test set of documents is identified. Similar to block 1056, the validation and test set of documents is taken from the identified documents of block 204 of FIG. 2. The validation set and test set of documents is used to validate and test the header model that is trained at block 214 of FIG. 2.

At block 1060, the header model is trained using the header training set. In embodiments, unlike the text model training described with respect to block 460 of FIG. 4 that may use a transformer model (e.g. DistilBERT), a deep learning model, for example XGBoost, may be used. A deep learning model may include various parameters such as a learning rate, epochs, and batch size. In embodiments there may be other parameters. In this example, a tree-based model may be used, and may start with a number of distinct trees that it will generate, with a maximum depth of any tree at a predetermined amount, for example a maximum depth of 7.

At block 1062, a determination is made whether training criteria are met. In embodiments, the training criteria may be a metric, for example a metric indicating a target loss accuracy, depth for recall at specified percentage, or F1 Measure. A depth for recall metric could be described as a target of capturing 80% of all privilege documents in the top 20% of the population by predicted privileged score. If the training criteria is not met, at block 1064 training parameters are updated and at block 1060 the header model is retrained given the updated training parameters. Note that in embodiments, if the loop has run a threshold value number of times in the model is still not able to meet the training criteria, then an error message may be sent to indicate further analysis of the header model is required, and the current criteria that are actually met may be indicated. In embodiments, the process 1000 may adjust parameters based on the results of prior training runs in an attempt to reach optimal goal metrics. In some embodiments, if the training criteria is not met, or if the training criteria is not met within a certain threshold amount, then the system will present results to the user and request approval or manual intervention before the process may move to block 1066.

Otherwise, if the training criteria are met, then at block 1066, the entire set of data, not just the training set data used, is scored using the model, and the score gets stored in the database. In embodiments, this data may be stored in relational database and used for general report and enrichment of documents in their source location.

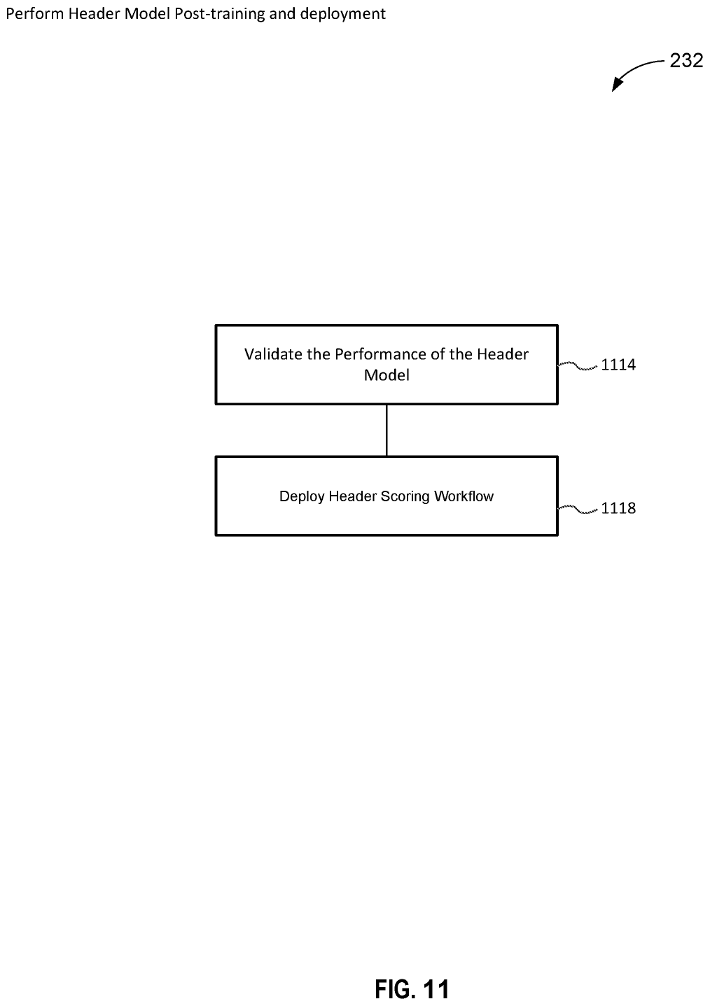

Referring now back to FIG. 2, at block 216, the process performs header model post training validation and deployment. The header model has been created with the desired performance metrics based on the training criteria from block 214. At this point, these performance metrics can be validated or reviewed. Block 216 is described in more detail with respect to FIG. 11. FIG. 11 illustrates an example process for header model post-training validation and deployment, in accordance with various embodiments.

At block 1114, the process validates the performance of the header model. In embodiments, this may be performed as a human quality control process prior to the text model portion of the privilege model being deployed. The user will review reporting showing all models and their model metrics, including precision, recall, F1, and depth for recall, and then confirm if the selected model should be deployed or if it should go to a manual process for additional model training.

At block 1118, the validated header model may then be deployed to a header scoring workflow. This deployment may be to a MLS to support scoring of new documents through the operational pipeline. This concludes the creation and validation of the header model portion of the privilege model.

Returning now to FIG. 2, at block 220, the privilege model is published. In embodiments, this includes making the privilege model, that includes the text model in conjunction with the header model, available for production document processing, such as described with respect to FIG. 12 below.

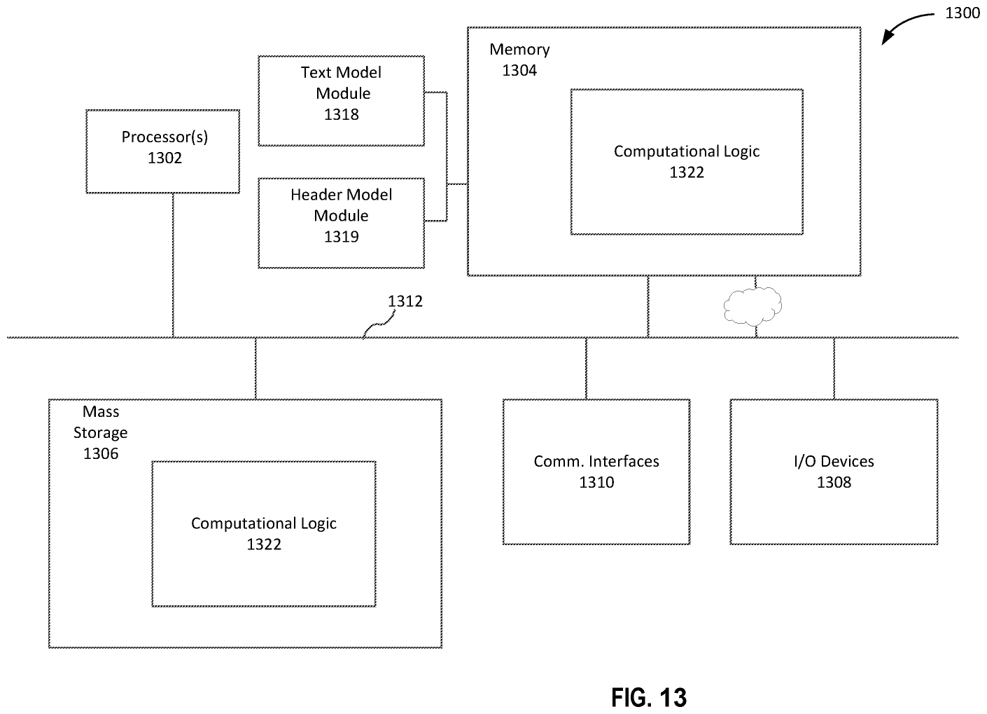

FIG. 12 illustrates an example process for using a machine learning-based privilege model to identify documents is privileged or not privileged, in accordance with various embodiments. FIG. 12 assumes that the privilege model, which includes a text privilege model and a header privilege model, has been trained and is ready for production. This process may be performed by computing device 1300 of FIG. 13, And in particular, with text model module 1318 and header model module 1319.

At block 1204, the process includes identifying documents. In embodiments, the identified documents will be determined to be privileged or not privileged based upon applying text and header contents of the document to the trained privilege model. In embodiments, the identified documents may include text documents, memos, graphs, charts, or other text-based documents. In embodiments, the identified documents may include one or more email messages including email messages nested within other email messages. At this point, the process splits into two blocks. At block 1208, the process may pre-process text. At block 1210, the process may pre-process headers.

Turning first to block 1208, document text may be preprocessed. This may include elements similar to block 206 of FIG. 2, to preprocess text model text for training. For example, documents may have extra “new lines” or other punctuation from the document removed, to get a closer to pure text. In addition, for documents that include email files, email headers may be removed. For example, these email headers may include To:, From:, CC:, and BCC: or Subject:. In embodiments, recipient names and email addresses may also be removed from the documents prior to applying them to the text privilege model. Block 1208 may also include tokenizing the text and convert it to a model specific format prior to application to the text privilege model. In embodiments, the model specific format may correspond to a tokenization of the text. This tokenized text may be in a specific format used by a particular transform algorithm, such as DistilBERT. In embodiments, a token may be identified by one or more words of text.

At block 1209, the resulting content of the documents from block 1208 is applied to the text privilege model, where the documents will receive a text score that indicates, based upon the text of the document, the likelihood that it is privileged. In embodiments, each document will receive its own text score, or a group of documents may receive a text score. In embodiments, the process may score each 512 length token segment identified above. Once the scores for each segment are calculated, the system creates a single score for each document record from the underlying segment scores. These scores may then be combined using statistical methods, for example a max segment score or mean segment scores. In embodiments, other statistical or mathematical methods may be used to combine the resulting scores. In embodiments, this resulting data may be stored in relational database and used for general reporting.

Returning now to block 1210, the process will pre-process headers. This may be similar to block 212 of FIG. 2 and blocks 342-354 of FIG. 3 to perform header model training. In embodiments, the documents may be filtered to identify whether any of the documents include emails. This filtering may include text searching documents to identify email headers, such as To:, From:, CC:, BCC: or Subject: keywords within the document. In addition, recipient names or recipient email addresses associated with the email headers may be identified. Finally, all text or other material not associated with email headers may be removed, leaving only the document with header information.

At block 1211, the resulting content of the email headers from block 1210 is applied to the header privilege model, where the document will receive a text score that indicates, based upon the email headers in the document, the likelihood that the document is privileged.

At block 1212, the text score and the header score for the document are combined. In embodiments, this combination may be a simple addition or an average of scores, or may be a more complicated function to produce a final numerical value. Based upon the final numerical value, a determination may be made whether the document is privileged or not privileged. In embodiments, the text score in the header score may be vectors that are combined to produce a final vector to indicate whether or not the document is privileged, and the likelihood, based upon the function of the scores, that the indication is correct.

At block 1220, results from each of the identified documents, whether or not they are individually or as a sub group privileged, is published. This may be published to a database, or to some of the report that is sent to individuals for review, or applied as an enrichment to the document in the original source system.

FIG. 13 illustrates an example computing device 1300 suitable for use with various disclosures herein, and in particular to FIGS. 1-12, in accordance with various embodiments.

As shown, computing device 1300 may include one or more processors or processor cores 1302 and system memory 1304. For the purpose of this application, including the claims, the terms “processor” and “processor cores” may be considered synonymous, unless the context clearly requires otherwise. The processor 1302 may include any type of processors, a microprocessor, and the like. The processor 1302 may be implemented as an integrated circuit having multi-cores, e.g., a multi-core microprocessor.

The computing device 1300 may include mass storage devices 1306 (such as diskette, hard drive, volatile memory (e.g., dynamic random-access memory (DRAM), compact disc read-only memory (CD-ROM), digital versatile disk (DVD), and so forth). In general, system memory 1304 and/or mass storage devices 1306 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory. Non-volatile memory may include, but is not limited to, electrically erasable programmable read-only memory, phase change memory, resistive memory, and so forth.

The computing device 1300 may further include I/O devices 1308 (such as a display (e.g., a touchscreen display)), keyboard, cursor control, remote control, gaming controller, image capture device, a camera, one or more sensors, and so forth) and communication interfaces 1310 (such as network interface cards, serial buses, modems, infrared receivers, radio receivers (e.g., Bluetooth), and so forth).

The communication interfaces 1310 may include communication chips (not shown) that may be configured to operate the device 1300 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond.

The above-described computing device 1300 elements may be coupled to each other via system bus 1312, which may represent one or more buses, and which may include, for example, PCIe buses. In other words, all or selected ones of processors 1302, memory 1304, mass storage 1306, communication interfaces 1310 and I/O devices 1308 may be PCIe devices. In particular, they may be within systems including interconnects incorporated with the teachings of the present disclosure to enable I3C pending read with retransmission, as earlier described. In the case of multiple buses, they may be bridged by one or more bus bridges (not shown). Each of these elements may perform its conventional functions known in the art. In particular, system memory 1304 and mass storage devices 1306 may be employed to store a working copy and a permanent copy of the programming instructions for the operation of various components of computing device 1300, including but not limited to an operating system of computing device 1300, one or more applications, and/or system software/firmware in support of practice of the present disclosure, collectively referred to as computing logic 1322, having a Text Model module 1318 and/or a Header Model module 1319. The various elements may be implemented by assembler instructions supported by processor(s) 1302 or high-level languages that may be compiled into such instructions.

The permanent copy of the programming instructions may be placed into mass storage devices 1306 in the factory, or in the field through, for example, a distribution medium (not shown), such as a compact disc (CD), or through communication interface 1310 (from a distribution server (not shown)). That is, one or more distribution media having an implementation of the agent program may be employed to distribute the agent and to program various computing devices.

The number, capability, and/or capacity of the elements 1302, 1304, 1306, 1308, 1310, and 1312 may vary, depending on whether computing device 1300 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, at least one of processors 1302 may be packaged together with computational logic 1322 configured to practice aspects of embodiments described herein to form a System in Package (SiP) or a System on Chip (SoC).

In various implementations, the computing device 1300 may be one or more components of a data center, a laptop, a netbook, a notebook, an ultrabook, a smartphone, a tablet, a personal digital assistant (PDA), an ultra mobile PC, a mobile phone, a digital camera, or an IoT user equipment. In further implementations, the computing device 1300 may be any other electronic device that processes data.

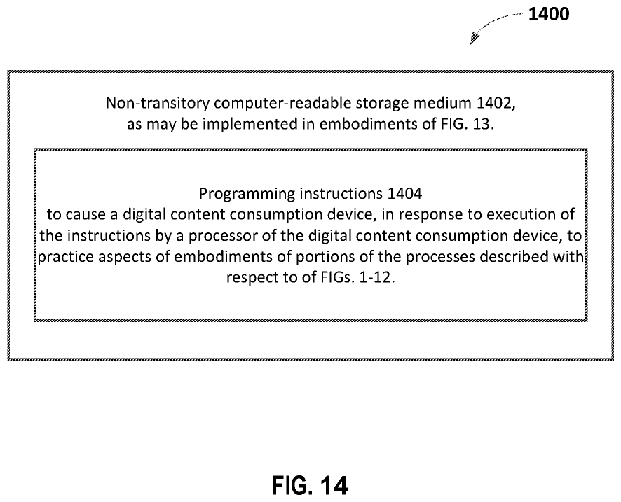

FIG. 14 depicts a computer-readable storage medium that may be used in conjunction with the computing device 1300, in accordance with various embodiments. FIG. 14 depicts a computer-readable storage medium that may be used in conjunction with the computing device 400, in accordance with various embodiments. Diagram 1400 illustrates an example non-transitory computer-readable storage media 1402 having instructions configured to practice all or selected ones of the operations associated with the processes described above. As illustrated, non-transitory computer-readable storage medium 1402 may include a number of programming instructions 1404 (e.g., including a Text Model module 1318 and Header Model module 1319). Programming instructions 1404 may be configured to enable a device, e.g., computing device 900, in response to execution of the programming instructions, to perform one or more operations of the processes described in reference to FIGS. 1-3. In alternate embodiments, programming instructions 1404 may be disposed on multiple non-transitory computer-readable storage media 1402 instead. In still other embodiments, programming instructions 1404 may be encoded in transitory computer-readable signals.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

### EXAMPLES

Example 1 may be a method for creating a privilege document model, the method comprising: identifying a plurality of documents to train the model; identifying a first set of the plurality of documents; modifying the first set of the plurality of documents for training a text-based portion of the model; training the text-based portion of the model based on the modified first set of the plurality of documents; identifying a second set of the plurality of documents; modifying the second set of the plurality of documents for training a header-based portion of the model; and training the header-based portion of the model based on the modified second set of the plurality of documents; wherein the privilege document model includes the trained text-based portion of the model and the trained header-based portion of the model.

Example 2 may include the method of example 1, wherein training the text-based portion of the model further includes validating the text-based portion of the model, and wherein training the header-based portion of the model further includes validating the header-based portion of the model.

Example 3 may include the method of example 1, wherein training the header-based portion of the model further includes identifying one or more headers within the first set of plurality of documents.

Example 4 may include the method of example 3, wherein training the header-based portion of the model further includes identifying one or more recipients associated with each of the one or more headers.

Example 5 may include the method of example 4, wherein the headers are email headers.

Example 6 is a method for determining whether a document is a privilege document, the method comprising: identifying the document; preprocessing the document to create a text sub-document to apply to a text portion of a privilege model; applying the text sub-document to the text portion of the privilege model to receive a first score; preprocessing the document to create a header sub-document to apply to a header portion of the privilege model; applying the header sub-document to the header portion of the privilege model to receive a second score; combining the first score and the second score; and determining, based upon the combined first score and the second score, whether the document is privileged or not privileged.

Example 7 may include the method of example 6, wherein the text sub-document does not include any header information.

Example 8 may include the method of example 6, wherein the text sub-document includes only text.

Example 9 may include the method of example 6, wherein the header is an email header.

Example 10 may include the method of example 9, wherein the header sub-document includes only headers and recipient information.

Example 11 is a non-transitory computer readable medium including code, when executed on a computing device, to cause the computing device to operate a privilege document model training engine to: identify a plurality of documents to train the model; identify a first set of the plurality of documents; modify the first set of the plurality of documents for training a text-based portion of the model; train the text-based portion of the model based on the modified first set of the plurality of documents; identify a second set of the plurality of documents; modify the second set of the plurality of documents for training a header-based portion of the model; and train the header-based portion of the model based on the modified second set of the plurality of documents; wherein the privilege document model includes the trained text-based portion of the model and the trained header-based portion of the model.

Example 12 may include the non-transitory computer readable medium of example 11, wherein to train the text-based portion of the model further includes to validate the text-based portion of the model, and wherein to train the header-based portion of the model further includes to validate the header-based portion of the model.

Example 13 may include the non-transitory computer readable medium of example 11, wherein to train the header-based portion of the model further includes to identify one or more headers within the first set of plurality of documents.

Example 14 may include the non-transitory computer readable medium of example 13, wherein to train the header-based portion of the model further includes to identify one or more recipients associated with each of the one or more headers. Example 15 may include the non-transitory computer readable medium of example 14, wherein the headers are email headers.

Example 16 is a non-transitory computer readable medium including code, when executed on a computing device, to cause the computing device to operate a privilege document identification engine to: identify a document; preprocess the document to create a text sub-document to apply to a text portion of a privilege model; apply the text sub-document to the text portion of the privilege model to receive a first score; preprocess the document to create a header sub-document to apply to a header portion of the privilege model; apply the header sub-document to the header portion of the privilege model to receive a second score; combine the first score and the second score; and determine, based upon the combined first score and the second score, whether the document is privileged or not privileged.

Example 17 may include the non-transitory computer readable medium of example 16, wherein the text sub-document does not include any header information.

Example 18 may include the non-transitory computer readable medium of example 16, wherein the text sub-document includes only text.

Example 19 may include the non-transitory computer readable medium of example 16, wherein the header is an email header.

Example 20 may include the non-transitory computer readable medium of example 9, wherein the header sub-document includes only headers and recipient information.

We claim:

1. A method for creating a privilege document model, the method comprising:
identifying a plurality of documents to train the model;
identifying a first set of the plurality of documents;
modifying the first set of the plurality of documents for training a text-based portion of the model;
training the text-based portion of the model based on the modified first set of the plurality of documents;
identifying a second set of the plurality of documents;
modifying the second set of the plurality of documents for training a header-based portion of the model; and
training the header-based portion of the model based on the modified second set of the plurality of documents; wherein the privilege document model includes the trained text-based portion of the model and the trained header-based portion of the model.

2. The method of claim 1, wherein training the text-based portion of the model further includes validating the text-based portion of the model, and wherein training the header-based portion of the model further includes validating the header-based portion of the model.

3. The method of claim 1, wherein training the header-based portion of the model further includes identifying one or more headers within the first set of plurality of documents.

4. The method of claim 3, wherein training the header-based portion of the model further includes identifying one or more recipients associated with each of the one or more headers.

5. The method of claim 4, wherein the headers are email headers.

6. A method for determining whether a document is a privilege document, the method comprising:
identifying the document;
preprocessing the document to create a text sub-document to apply to a text portion of a privilege model;
applying the text sub-document to the text portion of the privilege model to receive a first score;
preprocessing the document to create a header sub-document to apply to a header portion of the privilege model;
applying the header sub-document to the header portion of the privilege model to receive a second score;
combining the first score and the second score; and
determining, based upon the combined first score and the second score, whether the document is privileged or not privileged.

7. The method of claim 6, wherein the text sub-document does not include any header information.

8. The method of claim 6, wherein the text sub-document includes only text.

9. The method of claim 6, wherein the header is an email header.

10. The method of claim 9, wherein the header sub-document includes only headers and recipient information.

11. A non-transitory computer readable medium including code, when executed on a computing device, to cause the computing device to operate a privilege document model training engine to:
identify a plurality of documents to train the model;
identify a first set of the plurality of documents;
modify the first set of the plurality of documents for training a text-based portion of the model;
train the text-based portion of the model based on the modified first set of the plurality of documents;
identify a second set of the plurality of documents;
modify the second set of the plurality of documents for training a header-based portion of the model; and
train the header-based portion of the model based on the modified second set of the plurality of documents; wherein the privilege document model includes the trained text-based portion of the model and the trained header-based portion of the model.

12. The non-transitory computer readable medium of claim 11, wherein to train the text-based portion of the model further includes to validate the text-based portion of the model, and wherein to train the header-based portion of the model further includes to validate the header-based portion of the model.

13. The non-transitory computer readable medium of claim 11, wherein to train the header-based portion of the model further includes to identify one or more headers within the first set of plurality of documents.

14. The non-transitory computer readable medium of claim 13, wherein to train the header-based portion of the model further includes to identify one or more recipients associated with each of the one or more headers.

15. The non-transitory computer readable medium of claim 14, wherein the headers are email headers.

16. A non-transitory computer readable medium including code, when executed on a computing device, to cause the computing device to operate a privilege document identification engine to:
identify a document;
preprocess the document to create a text sub-document to apply to a text portion of a privilege model;
apply the text sub-document to the text portion of the privilege model to receive a first score;
preprocess the document to create a header sub-document to apply to a header portion of the privilege model;
apply the header sub-document to the header portion of the privilege model to receive a second score;
combine the first score and the second score; and
determine, based upon the combined first score and the second score, whether the document is privileged or not privileged.

17. The non-transitory computer readable medium of claim 16, wherein the text sub-document does not include any header information.

18. The non-transitory computer readable medium of claim 16, wherein the text sub-document includes only text.

19. The non-transitory computer readable medium of claim 16, wherein the header is an email header.

20. The non-transitory computer readable medium of claim 9, wherein the header sub-document includes only headers and recipient information.
